(19) United States
(12) Patent Application Publication
(10) Pub. No.: US 2022/0107410 A1
(43) Pub. Date: Apr. 7, 2022

(54) POSITION DETECTING DEVICE

(71) Applicant: TOYODA GOSEI CO., LTD., Kiyosu-shi (JP)

(72) Inventors: Ryusuke HORIBE, Kiyosu-shi (JP); Hiroshi YASUDA, Hirakata-shi (JP)

(21) Appl. No.: 17/485,640

(22) Filed: Sep. 27, 2021

(30) Foreign Application Priority Data
Oct. 1, 2020 (JP) 2020-167243

(51) Int. Cl. G01S 17/08

(52) U.S. Cl. CPC G01S 17/08

(57) ABSTRACT

A position detecting device includes a timing generating unit, light-emitting units, a light-receiving unit, a demodulating unit, an integrator, and a computation unit. The timing generating unit repeatedly and separately generates modulated signal streams of different phases at intervals. The light-emitting units emit optical signals that are intensity-modulated using the modulated signal streams. The light-receiving unit receives light reflected on an object and converts the reflected light into an electric signal. The computation unit calculates a position of the object based on an integration output of the integrator. Before integrating the signal wave that has a component a phase of which is synchronized with the current modulated signal stream, the integrator is preset to a final value of the integration output related to the signal wave that has a component a phase of which is synchronized with the previous modulated signal stream.

### BACKGROUND

### 1. Field

The present disclosure relates to a position detecting device that detects the position of an object.

### 2. Description of Related Art

Some position detecting devices, which detect the position of an object, are of an optical type (for example, Japanese Laid-Open Patent Publication No. 2011-215099).

The position detecting device disclosed in the publication includes light-emitting units, a light-receiving unit, and a position detecting unit (processing unit). The light-emitting units emit optical signals that are intensity-modulated using modulated signal streams of different phases. The light-receiving unit receives light reflected by the object and converts the received light into an electric signal. The position detecting unit (processing unit) detects the position of the object based on the electric signal.

When performing position detection, the position detecting device lights the light-emitting units sequentially and detects reflected light using the light-receiving unit. The received reflected light is input to the processing unit. Then, the position of the object is calculated (detected) based on the quantity of the detected reflected light, specifically, the electric signal input to the processing unit. When performing position detection, the position detecting device uses, as a detection parameter, the average of a signal wave that includes a component the phase of which is synchronized with the above-described modulated signal stream in the electric signal input to the processing unit.

Typically, a process of calculating an average of a signal wave is executed by using an integration circuit. The process of calculating an average using an integration circuit is performed by integrating the signal value of the signal wave over a specific period of time. The calculation thus takes time. Therefore, in the above-described position detecting device, which uses the average of a signal wave as a detection parameter, the time required to calculate the average is one of the factors that limit reduction in time for position detection.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a position detecting device is provided that includes a timing generating unit, light-emitting units, a light-receiving unit, a demodulating unit, an integrator, and a computation unit. The timing generating unit repeatedly and separately generates modulated signal streams of different phases at intervals. The light-emitting units emit optical signals that are intensity-modulated using the modulated signal streams of different phases. The light-receiving unit receives reflected light and converts the reflected light into an electric signal. The reflected light is the optical signal reflected by an object. The demodulating unit demodulates the electric signal to obtain a signal wave that has a component a phase of which is synchronized with one of the modulated signal streams of different phases. The integrator integrates the signal wave obtained by the demodulating unit. The computation unit calculates a position of the object based on an integration output of the integrator. Before integrating the signal wave that has a component a phase of which is synchronized with the current modulated signal stream, the integrator is preset to a final value of the integration output related to the signal wave that has a component a phase of which is synchronized with the previous modulated signal stream.

In a second general aspect, a position detecting device is provided that includes a timing generating unit, light-emitting units, a light-receiving unit, a demodulating unit, an integrator, and a computation unit. The timing generating unit repeatedly and separately generates modulated signal streams of different phases at intervals. The light-emitting units emit optical signals that are intensity-modulated using the modulated signal streams of different phases. The light-receiving unit receives reflected light and converts the reflected light into an electric signal. The reflected light is the optical signal reflected by an object. The demodulating unit demodulates the electric signal to obtain a signal wave that has a component a phase of which is synchronized with one of the modulated signal streams of different phases. The integrator integrates the signal wave obtained by the demodulating unit. The computation unit calculates a position of the object based on an integration output of the integrator. The integrator is set to a previously designated value during a period of time from when integration of the signal wave that has a component a phase of which is synchronized with the previous modulated signal stream is completed until when integration of the signal wave that has a component a phase of which is synchronized with the current modulated signal stream is started.

Other features and aspects will be apparent from the following detailed description, the drawings, and the claims.

### BRIEF DESCRIPTION OF THE DRAWINGS

FIG. 1 is a schematic diagram showing a distance detection mode of a position detecting device according to one embodiment.

FIG. 2 is an explanatory diagram illustrating manners in which detection is performed in the distance detection mode.

FIG. 3 is a schematic diagram showing a tilt angle detection mode of the position detecting device.

FIG. 4 is an explanatory diagram illustrating manners in which detection is performed in the tilt angle detection mode.

FIG. 5 is a schematic diagram showing a detection circuit of the position detecting device.

FIG. 6 is a timing diagram showing various signal waveforms in the detection circuit.

FIG. 7 is a simplified diagram of a circuit structure of a synchronous detection unit.

FIG. 8 is a timing diagram showing a superimposing period of a waveform distortion.

FIG. 9 is a timing diagram showing a manner in which an integrator is preset.

FIG. 10 is a timing diagram showing changes in an integration output of the integrator in a case in which the integrated value of the current integration process is greater than the integrated value of the previous integration process.

FIG. 11 is a timing diagram showing changes in an integration output of the integrator in a case in which the integrated value of the current integration process is less than the integrated value of the previous integration process.

FIG. 12 is a timing diagram showing changes in an integration output of an integrator in a position detecting device according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A position detecting device according to one embodiment will now be described.

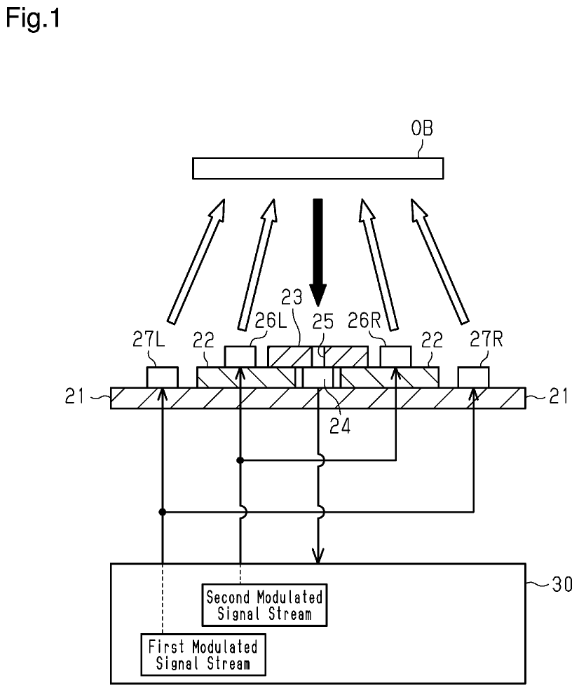

As shown in FIG. 1, the position detecting device of the present embodiment has a three-layer structure including a lower layer base 21, an intermediate layer base 22, and an upper layer base 23.

A light-receiving element 24 (a photodiode in the present embodiment) is provided on the lower layer base 21. The light-receiving element 24 detects the quantity of incident light. The light-receiving element 24 is located at the center of the lower layer base 21 on the side facing the intermediate layer base 22 (upper side as viewed in FIG. 1). The light-receiving element 24 is arranged in a gap between the lower layer base 21 and the upper layer base 23. The upper layer base 23 includes a through-hole (pinhole 25), which extends through the upper layer base 23 in a direction in which the bases are stacked (vertical direction as viewed in FIG. 1). The pinhole 25 is formed in a part that faces the light-receiving section of the light-receiving element 24. The position detecting device of the present embodiment has a structure in which external light is incident on the light receiving section of the light-receiving element 24 through the pinhole 25. In the present embodiment, the light-receiving element 24 corresponds to a light-receiving unit.

The position detecting device of the present embodiment includes four light-emitting elements 26L, 26R, 27L, 27R, which emit optical signals for position detection. In the present embodiment, the light-emitting elements 26L, 26R, 27L, 27R each include a light-emitting diode.

Two of the four light-emitting elements (inner light-emitting elements 26L, 26R) are provided on a surface of the intermediate layer base 22 that faces the upper layer base 23 (upper surface as viewed in FIG. 1). The upper layer base 23 is not provided in sections where the inner light-emitting elements 26L, 26R are provided. The inner light-emitting elements 26L, 26R are arranged so as to emit optical signals in a direction away from the intermediate layer base 22 (upward as viewed in FIG. 1).

The remaining two of the four light-emitting elements (outer light-emitting elements 27L, 27R) are provided on a surface of the lower layer base 21 that faces the intermediate layer base 22 (upper surface as viewed in FIG. 1). Neither the intermediate layer base 22 nor the upper layer base 23 is provided in sections where the outer light-emitting elements 27L, 27R are provided. The outer light-emitting elements 27L, 27R are arranged so as to emit optical signals in a direction away from the lower layer base 21 (upward as viewed in FIG. 1).

In the position detecting device of the present embodiment, the four light-emitting elements 26L, 26R, 27L, 27R and the light-receiving element 24 are arranged on a single straight line in a plan view (as viewed from the top in FIG. 1). Specifically, the inner light-emitting elements 26L, 26R are arranged on opposite sides of the light-receiving element 24, so as to be equally distanced from the light-receiving element 24. Also, the outer light-emitting elements 27L, 27R are arranged on opposite sides of the light-receiving element 24 and the inner light-emitting elements 26L, 26R, so as to be equally distanced from the light-receiving element 24. The outer light-emitting elements 27L, 27R are arranged on the outer sides of the inner light-emitting elements 26L, 26R in the direction which the four light-emitting elements 26L, 26R, 27L, 27R are arranged. In the position detecting device of the present embodiment, the distances between the inner light-emitting elements 26L, 26R and the light-receiving element 24 are shorter than the distances between the outer light-emitting elements 27L, 27R and the light-receiving element 24. In the present embodiment, the light-emitting elements 26L, 26R, 27L, 27R each correspond to a light-emitting unit.

The position detecting device of the present embodiment performs position detection of an object through synchronous detection.

The position detecting device of the present embodiment outputs, as drive signals for causing the light-emitting elements to blink, two types of modulated signal streams (a first modulated signal stream and a second modulated signal stream) of which the phases are displaced from each other by 90 degrees (specifically, a quarter of the wavelength). The first modulated signal stream and the second modulated signal stream are rectangular waves of a specific modulation frequency (40 kHz in the present embodiment).

When the position detecting device of the present embodiment performs position detection, a first light-emitting element LED1 is first driven by the first modulated signal stream to emit light. Then, after a phase delay of 90 degrees, a second light-emitting element LED2 is driven by the second modulated signal stream to emit light. Then, optical signals of the light-emitting elements LED1, LED2 (specifically, the quantity of light reflected by an object OB) are detected by the light-receiving element 24. Thereafter, the position of the object OB (specifically, the distance and the tilt angle) is detected based on the quantity of the reflected light detected by the light-receiving element 24.

The execution modes of the position detecting device includes a distance detection mode for detecting the distance to the object OB. The distance detection mode will now be described.

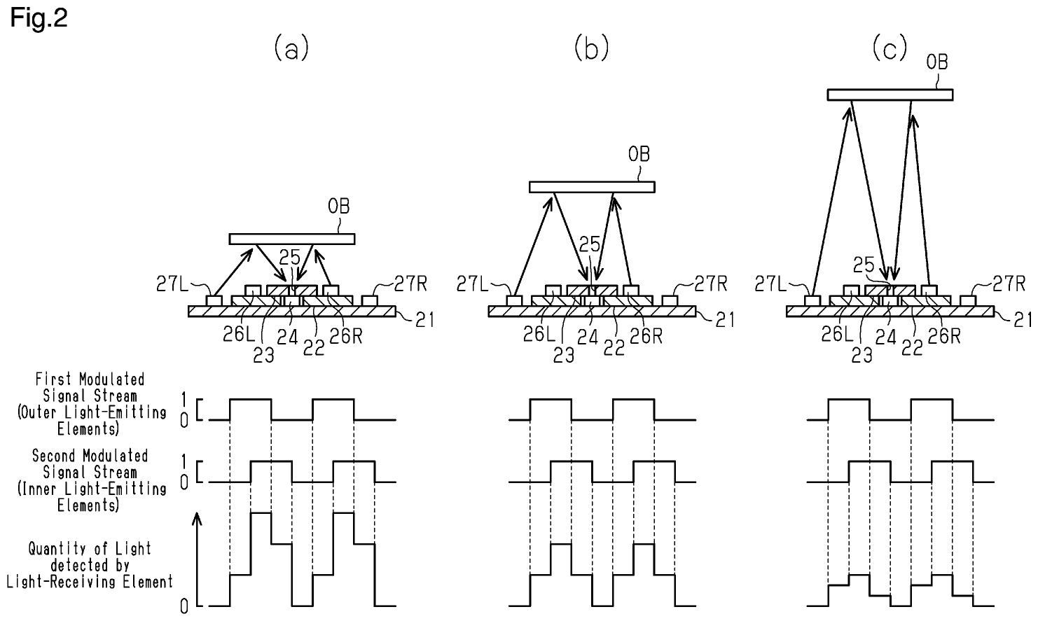

As shown in FIGS. 1 and 2, the distance detection mode uses the outer light-emitting elements 27L, 27R as the first light-emitting elements LED1, and uses the inner light-emitting elements 26L, 26R as the second light-emitting elements LED2. Specifically, the outer light-emitting elements 27L, 27R are driven by the first modulated signal stream to emit light, and the inner light-emitting elements 26L, 26R are driven by the second modulated signal stream to emit light. The distance detection mode is preferably configured such that the quantity of the optical signals emitted by the outer light-emitting elements 27L, 27R is greater than the quantity of the optical signals emitted by the inner light-emitting elements 26L, 26R. The ratio is set to, for example, 2:1.

When the distance to the object OB is relatively short as shown in section (a) of FIG. 2, the angle at which the optical signals of the outer light-emitting elements 27L, 27R (specifically, the light reflected by the object OB) are incident on the pinhole 25 (angle of incidence) is relatively large, and the optical path lengths are relatively long. Thus, the quantity of reflected light that is emitted by the outer light-emitting elements 27L, 27R and enters the light-receiving element 24, that is, a quantity VD1 of reflected light detected by the light-receiving element 24 is relatively small. The inner light-emitting elements 26L, 26R are closer to the light-receiving element 24 than the outer light-emitting elements 27L, 27R. Thus, the angle of incidence on the pinhole 25 of the optical signals of the inner light-emitting elements 26L, 26R (specifically, light reflected by the object OB) is smaller than the angle of incidence of the optical signals of the outer light-emitting elements 27L, 27R. Also, the optical path lengths are relatively short. Thus, the quantity of reflected light that is emitted by the inner light-emitting elements 26L, 26R and is incident on the light-receiving element 24, that is, a quantity VD2 of the reflected light detected by the light-receiving element 24 is relatively large.

In the position detecting device of the present embodiment, the quantity of the optical signals of the outer light-emitting elements 27L, 27R is set to be twice the quantity of the optical signals of the inner light-emitting elements 26L, 26R. However, when the distance to the object OB is relatively short, a detected value (the light quantity VD2) related to the optical signals of the inner light-emitting elements 26L, 26R is greater than a detected value (the light quantity VD1) related to the optical signals of the outer light-emitting elements 27L, 27R. In this case, a ratio RD of the light quantities VD1 and VD2 (RD=VD1/VD2) is less than 1. The shorter the distance to the object OB, the smaller the value of the ratio RD becomes.

When the distance to the object OB is increased so as to be an intermediate distance as shown in section (b) of FIG. 2, the difference between the angle of incidence of the inner light-emitting elements 26L, 26R and the angle of incidence of the outer light-emitting elements 27L, 27R is reduced. This reduces the difference between the detected value (the light quantity VD2) related to the optical signals of the inner light-emitting elements 26L, 26R and the detected value (the light quantity VD1) related to the optical signals of the outer light-emitting elements 27L, 27R. In this case, the ratio RD of the light quantities VD1 and VD2 (RD=VD1/VD2) approaches 1. In the example shown in section (b) of FIG. 2, the light quantities VD1 and VD2 are equal to each other, and the ratio RD of the light quantities VD1 and VD2 (RD=VD1/VD2) is 1.

When the distance to the object OB is further increased as shown in section (c) of FIG. 2, the difference between the angle of incidence of the inner light-emitting elements 26L, 26R and the angle of incidence of the outer light-emitting elements 27L, 27R is substantially 0. Accordingly, the relationship between the light quantities VD1 and VD2 approaches the relationship between the quantity of the optical signals emitted by the outer light-emitting elements 27L, 27R and the quantity of the optical signals emitted by the inner light-emitting elements 26L, 26R. That is, in this case, the detected value (the light quantity VD1) related to the outer light-emitting elements 27L, 27R approaches a value twice the detected value (light quantity VD2) of the optical signals of the inner light-emitting elements 26L, 26R, and the ratio RD of the light quantities VD1 and VD2 (RD=VD1/VD2) approaches 2. In the example shown in section (c) of FIG. 2, the light quantity VD1 is twice the light quantity VD2, and the ratio RD of the light quantities VD1 and VD2 (RD=VD1/VD2) is 2.

In the distance detection mode, a distance DIS to the object OB is detected based on the above-described relationship between the light quantities VD1, VD2 and the distance to the object OB. Specifically, the light quantities VD1, VD2 are detected, and the distance to the object OB is calculated (detected) based on the ratio RD of the light quantities VD1 and VD2 (RD=VD1/VD2).

The execution modes of the position detecting device includes a tilt angle detection mode for detecting a tilt angle of the object OB. The tilt angle detection mode will now be described.

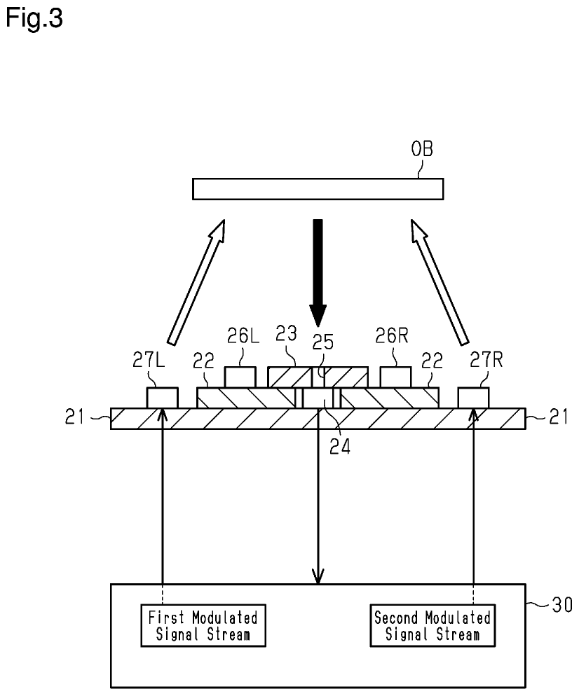

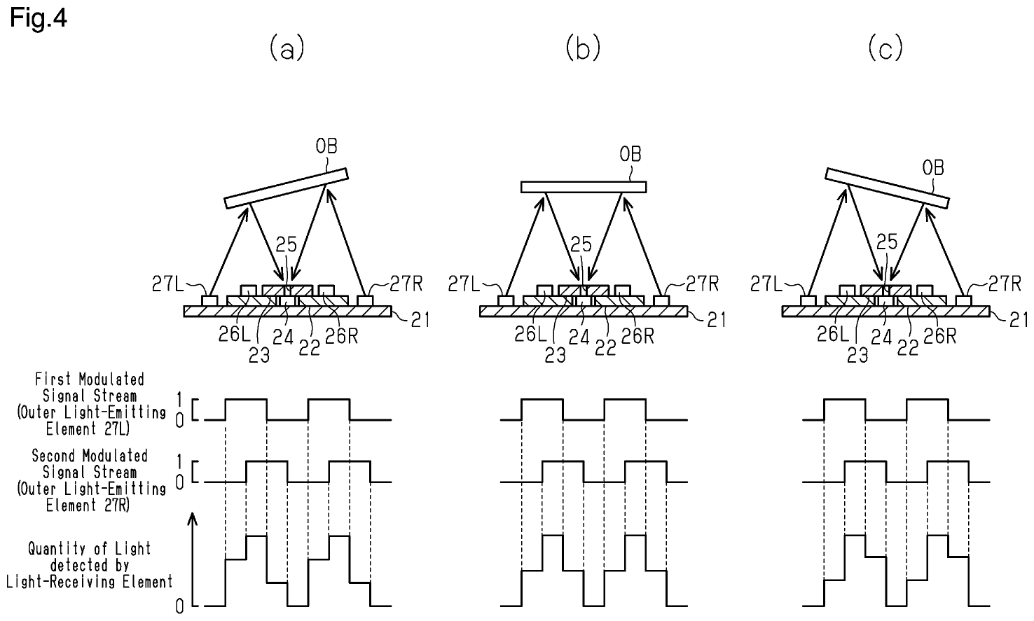

As shown in FIGS. 3 and 4, the tilt angle detection mode uses one of the outer light-emitting elements 27L, 27R (the outer light-emitting element 27L) as the first light-emitting element LED1, and uses the other one of the outer light-emitting elements 27L, 27R (the outer light-emitting element 27R) as the second light-emitting element LED2. Specifically, the outer light-emitting element 27L is driven by the first modulated signal stream to emit light. Then, after a phase delay of 90 degrees, the outer light-emitting element 27R is driven by the second modulated signal stream to emit light. In the tilt angle detection mode, the quantities of light emitted by the outer light-emitting elements 27L, 27R are set to be equal to each other.

When the object OB is inclined toward the outer light-emitting element 27L (to the left as viewed in FIG. 4) as shown in section (a) of FIG. 4, the distance between the outer light-emitting element 27L and the object OB is shorter than the distance between the outer light-emitting element 27R and the object OB. Accordingly, a path (optical path L1) of the light that is emitted by the outer light-emitting element 27L and is incident on the light-receiving element 24 is shorter than a path (optical path L2) of the light that is emitted by the outer light-emitting element 27R and is incident on the light-receiving element 24.

The quantity of the reflected light that is incident on the light-receiving element 24 is proportionate to the inverse square of the length of the optical path of the reflected light. Thus, as for the outer light-emitting element 27L, which has a relatively short optical path, a relatively large quantity of reflected light is detected by the light-receiving element 24. That is, a quantity VA1 of the light reflected by the object OB that is resultant of the optical signal emitted by the outer light-emitting element 27L is relatively large. In contrast, as for the outer light-emitting element 27R, which has a relatively long optical path, a relatively small quantity of reflected light is detected by the light-receiving element 24. That is, a quantity VA2 of the light reflected by the object OB that is resultant of the optical signal emitted by the outer light-emitting element 27R is relatively small.

Although the quantities of optical signals emitted by the outer light-emitting elements 27L and 27R are set to be equal to each other, the detected value (the light quantity VA1) related to the optical signal of the outer light-emitting element 27L is greater than the detected value (the light quantity VA2) related to the optical signal of the outer light-emitting element 27R. The ratio RA of the light quantities VA1 and VA2 (RA=VA1/VA2) is greater than 1 (RA>1). The larger the tilt angle of the object OB toward the outer light-emitting element 27L, the larger the value of the ratio RA becomes.

When the object OB faces the position detecting device squarely as shown in section (b) of FIG. 4 (tilt angle=0 degrees), the distances between the outer light-emitting elements 27L, 27R and the object OB are equalized. Thus, the path of the light that is emitted by the outer light-emitting element 27L and is incident on the light-receiving element 24 (optical path L1) is equal to the path of the light that is emitted by the outer light-emitting element 27R and is incident on the light-receiving element 24 (optical path L2). In this case, the detected value (the light quantity VA1) of the optical signal of the outer light-emitting element 27R is equal to the detected value (the light quantity VA2) of the optical signal of the outer light-emitting element 27R, and the ratio RA of the light quantities VA1 and VA2 (RA=VA1/VA2) becomes 1.

When the object OB is inclined toward the outer light-emitting element 27R (to the right as viewed in FIG. 4) as shown in section (c) of FIG. 4, the distance between the outer light-emitting element 27L and the object OB is longer than the distance between the outer light-emitting element 27R and the object OB. Accordingly, a path (optical path L1) of the light that is emitted by the outer light-emitting element 27L and is incident on the light-receiving element 24 is longer than a path (optical path L2) of the light that is emitted by the outer light-emitting element 27R and is incident on the light-receiving element 24.

Thus, as for the outer light-emitting element 27L, which has a relatively long optical path, a relatively small quantity of reflected light is detected by the light-receiving element 24. That is, a quantity VA1 of the light reflected by the object OB that is resultant of the optical signal emitted by the outer light-emitting element 27L is relatively small. In contrast, as for the outer light-emitting element 27R, which has a relatively short optical path, a relatively large quantity of reflected light is detected by the light-receiving element 24. That is, a quantity VA2 of the light reflected by the object OB that is resultant of the optical signal emitted by the outer light-emitting element 27R is relatively large.

Although the quantities of optical signals emitted by the outer light-emitting elements 27L and 27R are set to be equal to each other, the detected value (the light quantity VA1) related to the optical signal of the outer light-emitting element 27L is less than the detected value (the light quantity VA2) related to the optical signal of the outer light-emitting element 27R. In this case, the ratio RA of the light quantities VA1 and VA2 (RA=VA1/VA2) is less than 1 (RA<1). The larger the tilt angle of the object OB toward the outer light-emitting element 27R, the smaller the value of the ratio RA becomes.

In the tilt angle detection mode, a tilt angle of the object OB is detected based on the above-described relationship between the light quantities VA1, VA2 and the tilt angle of the object OB. Specifically, the light quantities VA1, VA2 are detected, and a tilt angle TIL of the object OB is calculated (detected) based on the ratio RA of the light quantities VA1 and VA2 (RA=VD1/VD2). The relationship between the optical paths L1 and L2 changes in accordance with the distance between the object OB and the position detecting device. Thus, the ratio RA changes in accordance with the distance. Accordingly, when detecting the tilt angle TIL of the object OB, the position detecting device of the present embodiment uses the distance DIS as a detection parameter, in addition to the ratio RA.

Hereinbelow, a detection circuit will be described that detects the quantities of light that is emitted by the light-emitting elements 26L, 26R, 27L, 27R and reflected by the object OB (specifically, the value V1, which corresponds to the light quantities VD1, VA1, and the value V2, which corresponds to the light quantities VD2, VA2). The detection circuit includes a microprocessor and is configured to execute various processes by executing specific software using the microprocessor.

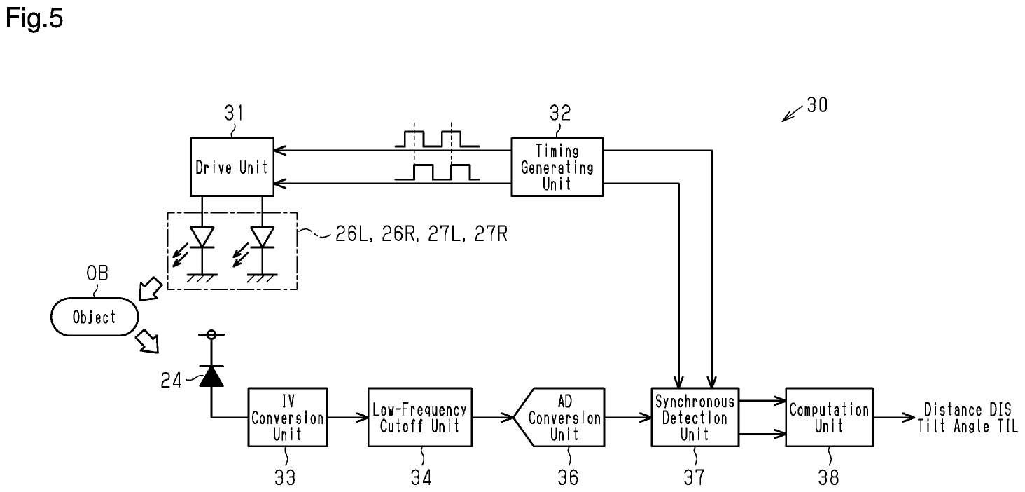

As shown in FIG. 5, the detection circuit 30 includes a configuration for emitting optical signals, which includes the light-emitting elements 26L, 26R, 27L, 27R, a drive unit 31, and a timing generating unit 32. The drive unit 31 drives the light-emitting elements 26L, 26R, 27L, 27R to emit light. The timing generating unit 32 generates the first modulated signal stream and the second modulated signal stream.

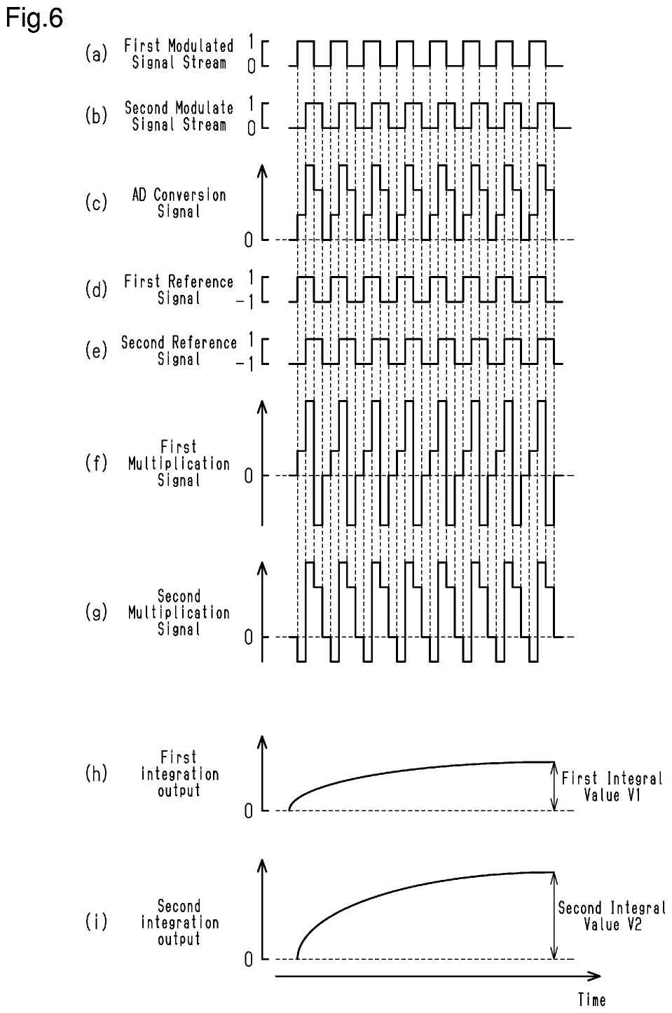

As shown in FIG. 6, the timing generating unit 32 repeatedly and separately generates two types of modulated signal streams including signals having rectangular waves at specific intervals over a previously defined period of time. The phases of the modulated signal streams are displaced from each other by 90 degrees. The duty cycle of the modulated signal streams is 50%. The modulated signal streams include a first modulated signal stream (section (a) in FIG. 6)) and a second modulated signal stream (section (b) in FIG. 6).

As shown in FIG. 5, the timing generating unit 32 outputs the first modulated signal stream and the second modulated signal stream to the drive unit 31. The drive unit 31 selectively causes the light-emitting elements 26L, 26R, 27L, 27R to emit light based on the first modulated signal stream and the second modulated signal stream. In the distance detection mode, the inner light-emitting elements 26L, 26R are driven to emit light based on the first modulated signal stream, and the outer light-emitting elements 27L, 27R are driven to emit light based on the second modulated signal stream. In the tilt angle detection mode, the outer light-emitting element 27L is driven to emit light based on the first modulated signal stream, and the outer light-emitting element 27R is driven to emit light based on the second modulated signal stream.

The detection circuit 30 includes a configuration for detecting the quantity of the reflected light, which includes the light-receiving element 24, an IV conversion unit 33, a low-frequency cutoff unit 34, an AD conversion unit 36, a synchronous detection unit 37, and a computation unit 38, which are arranged in order from the light-receiving element 24.

The light-receiving element 24 is configured to output a current signal that corresponds to the quantity of reflected light that is incident on the light-receiving element 24.

The IV conversion unit 33 receives the current signal output from the light-receiving element 24. The IV conversion unit 33 converts the input current signal into a voltage signal and outputs the voltage signal.

The low-frequency cutoff unit 34 is a high-pass filter circuit. The low-frequency cutoff unit 34 receives the voltage signal (IV conversion signal) output from the IV conversion unit 33. The low-frequency cutoff unit 34 is configured to attenuate a signal component in the IV conversion signal that has a frequency lower than the cutoff frequency (1 kHz in the present embodiment).

The AD conversion unit 36 is configured to convert an analog signal into a digital signal. The AD conversion unit 36 performs signal conversion through sampling at a frequency (5 MHz in the present embodiment) higher than the modulation frequency. The AD conversion unit 36 receives a low-frequency cutoff signal output from the low-frequency cutoff unit 34. The AD conversion unit 36 converts the low-frequency cutoff signal into a digital signal (16-bit signal (65536 steps) in the present embodiment) and outputs the digital signal. As shown in section (c) in FIG. 6, the signal output from the AD conversion unit 36 (AD conversion signal) has a value obtained by superimposing the value V1 and the value V2. The value V1 corresponds to the quantity of the reflected light (the light quantities VD1, VA1) related to the optical signal emitted by the first light-emitting element LED1 based on the first modulated signal stream. The value V2 corresponds to the quantity of the reflected light (the light quantities VD2, VA2) related to the optical signal emitted by the second light-emitting element LED2 based on the second modulated signal stream.

A generally-used anti-aliasing filter may be provided at a stage prior to the AD conversion unit 36, in order to suppress the occurrence of aliasing during AD conversion.

The synchronous detection unit 37 includes a two-phase lock-in amplifier.

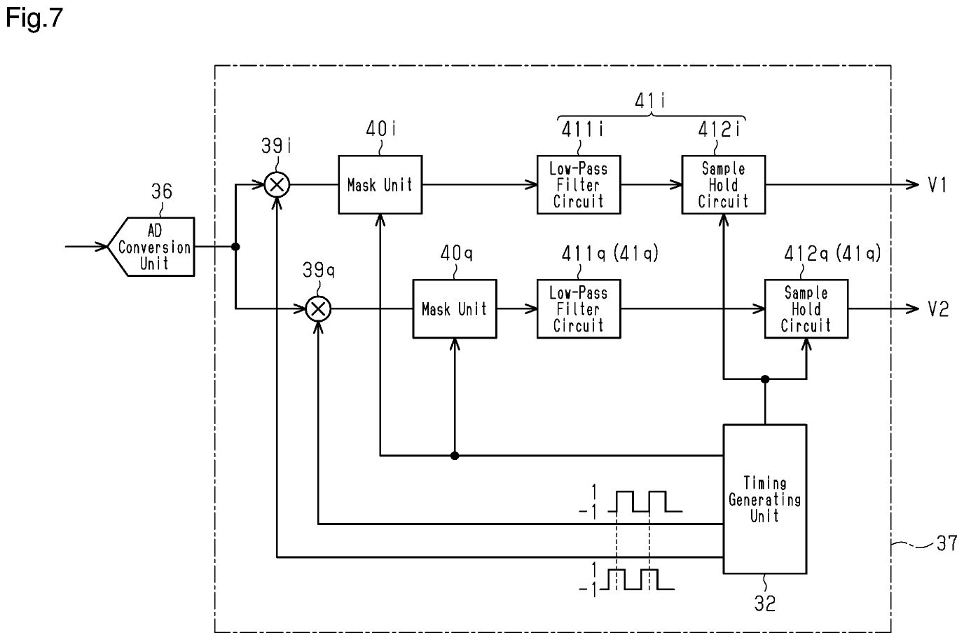

As shown in FIG. 7, the synchronous detection unit 37 includes multipliers 39i, 39q and mask units 40i, 40q. The multipliers 39i, 39q multiply a measurement signal (AD conversion signal) by a reference signal (the first modulated signal stream or the second modulated signal stream). The mask units 40i, 40q decimate a signal value output from the multipliers 39i, 39q (a first multiplication signal or a second multiplication signal). In the present embodiment, the multiplier 39i corresponds to a demodulating unit that demodulates the electric signal (AD conversion signal) to obtain a signal wave (specifically, the first multiplication signal) that has a component the phase of which is synchronized with the first modulated signal stream. The multiplier 39q corresponds to a demodulating unit that demodulates the AD conversion signal to obtain a signal wave (specifically, the second multiplication signal) that has a component the phase of which is synchronized with the second modulated signal stream. The decimation of the first multiplication signal and the second multiplication signal performed by the mask units 40i, 40q will be discussed below.

The synchronous detection unit 37 also includes integrators 41i, 41q. The integrators 41i, 41q integrate the first multiplication signal or the second multiplication signal, which have been decimated by the mask units 40i, 40q. The integrators 41i, 41q include low-pass filter circuits 411i, 411q and sample hold circuits 412i, 412q.

The following basically describes the process through which the synchronous detection unit 37 calculates, the value V1 corresponding to the quantity of reflected light (the light quantities VD1, VA1) related to the optical signal emitted by the first light-emitting element LED1 based on the first modulated signal stream. First, the multiplier 39i multiplies the AD conversion signal (section (c) in FIG. 6), which is a measurement signal, by the first modulated signal stream, which is a reference signal (specifically, a first reference signal shown in section (d) in FIG. 6 output from the timing generating unit 32). The first multiplication signal output from the multiplier 39i (section (f) in FIG. 6) is decimated by the mask unit 40i and integrated by the integrator 41i as shown in section (h) in FIG. 6. The value integrated by the integrator 41i is output as the value V1.

The following describes the process through which the synchronous detection unit 37 calculates the value V2 corresponding to the quantity of the reflected light (the light quantities VD2, VA2) related to the optical signal emitted based on the second modulated signal stream. First, the multiplier 39q multiplies the AD conversion signal (section (c) in FIG. 6), which is a measurement signal, by the second modulated signal stream, which is a reference signal (specifically, a second reference signal shown in section (e) in FIG. 6 output from the timing generating unit 32). The second multiplication signal output from the multiplier 39q (section (g) in FIG. 6) is decimated by the mask unit 40q and integrated by the integrator 41q as shown in section (i) in FIG. 6. The value integrated by the integrator 41q is output as the value V2.

The computation unit 38 calculates and outputs the distance DIS to the object OB through a computation process based on the values V1, V2, and calculates and outputs the tilt angle TIL of the object OB through a computation process based on the distance DIS and the value V1, V2. Specifically, the distance detection mode calculates the distance DIS to the object OB, from a relationship (for example, arithmetic expressions and operation tables) that is stored in the computation unit 38 in advance and based on the value V1 (the light quantity VD1) and the value V2 (the light quantity VD2). The tilt angle detection mode calculates the tilt angle TIL of the object OB, from a relationship (for example, arithmetic expressions and operation tables) that is stored in the computation unit 38 in advance and based on the value V1 (the light quantity VA1), the value V2 (the light quantity VA2), and the distance DIS.

In the position detecting device of the present embodiment, the influence of parasitic inductance and parasitic capacitance of the detection circuit 30 may cause a waveform distortion (such as rounding and signal delay of the waveform) at the timing of signal level transition of an analog signal. Such a waveform distortion is one of the factors that reduces the accuracy of position detection by the position detecting device. The position detecting device of the present embodiment prohibits the integration process in the integrators 41i, 41q during a period of time from when a transition of the signal level of the first modulated signal stream takes place until a defined period of time elapses. Also, the position detecting device prohibits the integration process during a distortion superimposing period T1 from when a transition of the signal level of the second modulated signal stream takes place until when a defined period of time elapses. In the distortion superimposing period T1, a waveform distortion may occur.

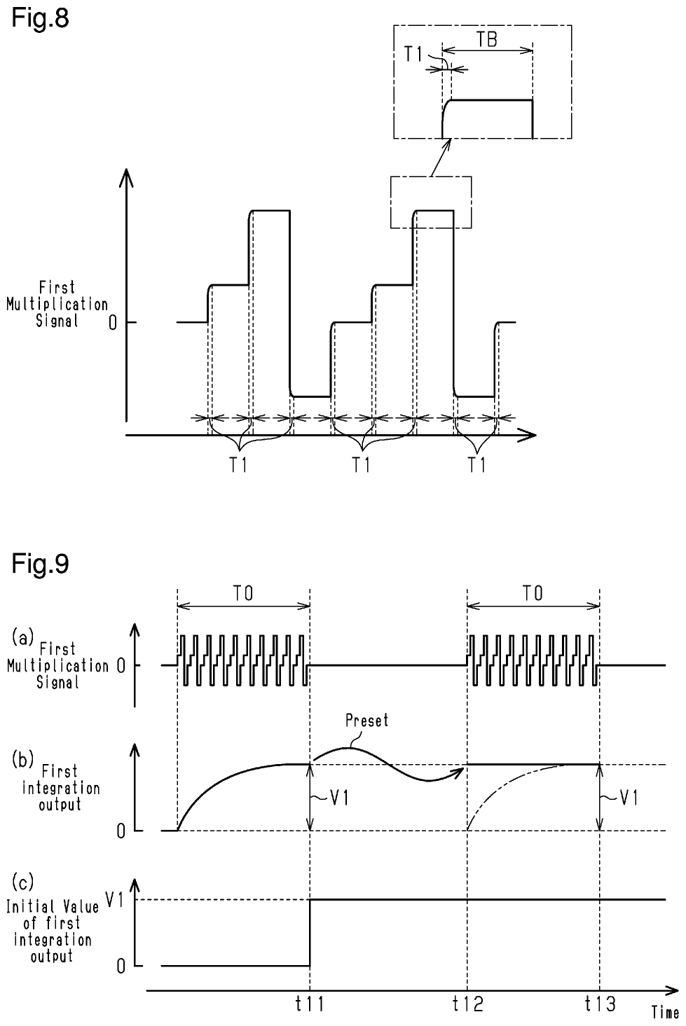

As in an example illustrated in FIG. 8, the position detecting device of the present embodiment prohibits integration of the first multiplication signal during the distortion superimposing period T1, at the integration of the first multiplication signal (refer to section (f) of FIG. 6) by the integrator 41i. This decimates the signal value of the first multiplication signal during the distortion superimposing period T1 at the integration of the first multiplication signal by the integrator 41i.

Also, the position detecting device of the present embodiment prohibits integration of the second multiplication signal during the distortion superimposing period T1, at the integration of the second multiplication signal (refer to section (g) of FIG. 6) by the integrator 41q. This decimates the signal value of the second multiplication signal during the distortion superimposing period T1 at the integration of the second multiplication signal by the integrator 41q.

The process of prohibiting integration in digital signal processing can be implemented by stopping a circuit that performs successive integration or by stopping an operation clock.

In the present embodiment, the process of decimating the signal value of the first multiplication signal (or the second multiplication signal) is executed by the mask units 40i, 40q based on the timing signal output from the timing generating unit 32. Specifically, in the distortion superimposing period T1, which is specified based on the timing signal, the integrator 41i (specifically, the low-pass filter circuit 411i) is prohibited from acquiring the signal value of the first multiplication signal. Accordingly, the integrator 41i executes an integration process using the first multiplication signal, of which the signal value in the distortion superimposing period T1 has been decimated. Also, in the distortion superimposing period T1, which is specified based on the timing signal, the integrator 41q (specifically, the low-pass filter circuit 411q) is prohibited from acquiring the signal value of the second multiplication signal. Accordingly, the integrator 41q executes an integration process using the second multiplication signal, of which the signal value in the distortion superimposing period T1 has been decimated.

During the distortion superimposing period T1, in which a waveform distortion may be superimposed on the first multiplication signal and the second multiplication signal, the present embodiment does not use the signal value of the first multiplication signal for the integration process in the integrator 41i, and does not use the signal value of the second multiplication signal for the integration process in the integrator 41q. The calculation accuracy of the integrated values (specifically, the first integrated value V1 and the second integrated value V2) is thus not reduced by superposition of a waveform distortion. This limits reduction in the position detection accuracy of the position detecting device.

The position detecting device of the present embodiment minimizes the influence of the waveform distortion by extending the period of time during which integration of the multiplication signals by the integrators 41i, 41q is prohibited. This, on the other hand, shortens the integration process time, and may thus reduce the position detection accuracy. That is, since the amount of signal used in the integration process by the integrators 41i, 41q is reduced, the detection accuracy will be reduced.

Taking the above into consideration, the present embodiment sets the period of time during which the integration of multiplication signals by the integrators 41i, 41q is prohibited (the distortion superimposing period T1 in the present embodiment) to a period of time that properly limits reduction in the position detection accuracy due to a waveform distortion, and ensures a sufficient amount of signal used in the integration of multiplication signals by the integrators 41i, 41q. Specifically, the distortion superimposing period T1 is determined such that a ratio RT of the distortion superimposing period T1 to an interval (TB) of transition timing of the signal level (RT=T1/TB×100%) is 10% as shown in FIG. 8. In the present embodiment, in order to obtain appropriate values as integrated values that are calculated by the integrators 41i, 41q (the first integrated value V1 and the second integrated value V2), the distortion superimposing period T1 is preferably determined such that the ratio RT satisfies the expression 0%<RT≤10%.

The position detecting device of the present embodiment uses, as detection parameters, the first integrated value V1 and the second integrated value V2, which are values integrated by the integrators 41i, 41q.

As in an example illustrated in FIG. 9, the position detecting device of the present embodiment executes the integration process using the integrators 41i, 41q by integrating the first multiplication signal and the second multiplication signal for a specific period of time (specifically, a modulation period T0). Since the modulation frequency component must be suppressed, the specific period of time is set to a period of time that is sufficiently long as compared to time corresponding to the reciprocal of the modulation frequency.

The final values of the integration outputs of the integrators 41i, 41q in the modulation period T0 are calculated as the integrated values V1, V2. In the present embodiment, the time required to calculate the integrated values V1, V2 using the integrators 41i, 41q is one of the factors that limit reduction in time for position detection.

Taking the above into consideration, the position detecting device of the present embodiment presets, prior to the execution of the integration process by the integrators 41i, 41q, the integrators 41i, 41q to the integrated values that were calculated by the integrators 41i, 41q in the previous integration process (the first integrated value V1 or the second integrated value V2). Specifically, as in the example illustrated in FIG. 9, when the integration process is executed by the integrator 41i, the final value of the first integration output in the modulation period T0 is output as the first integrated value V1 at a point in time t11. The initial value of the first integration output of the integrator 41i is set to the first integrated value V1. Also, when the integration process is executed by the integrator 41q, the final value of the second integration output in the modulation period T0 is output as the second integrated value V2. The initial value of the second integration output of the integrator 41q is set to the second integrated value V2.

Operational advantages achieved by executing the integration process using the integrators 41i, 41q will now be described.

According to the present embodiment, prior to the execution of the integration process by the integrators 41i, 41q, the initial values of the integration outputs of the integrators 41i, 41q are set to the final values of the previous integration outputs, that is, values close to the final values of the integration outputs of the integrators 41i, 41q in the current integration process.

FIG. 9 shows changes in the first integration output of the integrator 41i in a case in which the first integrated value V1 calculated in the previous integration process and the first integrated value V1 calculated in the current integration process are equal to each other. In this case, as obvious in FIG. 9, the first integration output of the integrator 41i in the current integration process (from a point in time t12 to a point in time t13) agrees with the first integrated value V1, which is the final value of the first integration output of the integrators 41i, 41q from the beginning of the current integration process. Thus, in this case, at the execution of the integration process by the integrator 41i, the first integration output of the integrator 41i is changed to a value equal to the time integral of the first multiplication signal (the first integrated value V1) at an early stage.

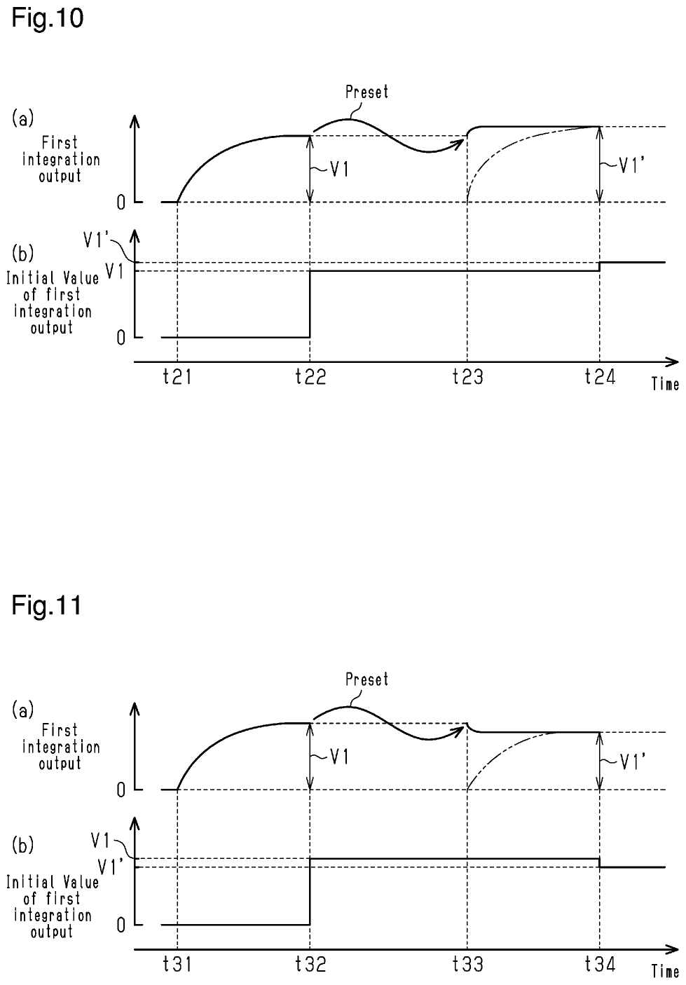

FIG. 10 is a timing diagram showing changes in the first integration output of the integrator 41i in a case in which a first integrated value V1′ calculated by the current integration process (from a point in time t23 to a point in time t24) is greater than the first integrated value V1 calculated in the previous integration process (from a point in time t21 to a point in time t22). Also, FIG. 11 is a timing diagram showing changes in the first integration output of the integrator 41i in a case in which the first integrated value V1′ calculated by the current integration process (from a point in time t33 to a point in time t34) is less than the first integrated value V1 calculated in the previous integration process (from a point in time t31 to a point in time t32). In either case, as obvious from FIGS. 10 and 11, the first integration output of the integrator 41i in the current integration process changes to and agrees with the final value of the first integration output of the integrator 41i (the first integrated value V1′) at an early stage as compared to a case in which the initial value of the first integration output is set to 0 (as indicated by the long-dash double-short-dash lines in FIGS. 10 and 11). Thus, in either of the example shown in FIG. 10 and the example shown in FIG. 11, at the execution of the integration process by the integrator 41i, the first integration output of the integrator 41i is changed to a value equal to the time integral of the first multiplication signal (the first integrated value V1) at an early stage.

The integration process by the integrator 41q is similar to the integration process by integrator 41i. That is, the second integration output of the integrator 41q is changed to a value equal to the time integral of the second multiplication signal at an early stage in any of the following cases: a case in which the second integrated value in the previous integration process (the previous integrated value) is equal to the second integrated value in the current integration process (the current integrated value); a case in which the current integrated value is greater than the previous integrated value; and a case in which the current integrated value is less than the previous integrated value.

Thus, unlike a case in which the integrators 41i, 41q are not preset to the previous integrated values prior to the execution of the integration process by the integrators 41i, 41q, appropriate values (values equal to the time integrals of the first multiplication signal or the second multiplication signal) are acquired as the final values of the integration outputs of the integrators 41i, 41q in the modulation period T0, even if the modulation period T0 is short. Since this allows the modulation period T0 to be shortened, the position detecting device is capable of performing position detection of an object quickly and shortening the updating cycle of detection.

In the present embodiment, based on various experiments and simulations performed by the inventors, the modulation period T0 is set to a period of time that satisfies the following Condition A and Condition B. The present embodiment is practically applicable to usage conditions in which the position detection value changes continuously.

Condition A: In a device in which the integrators 41i, 41q are not preset to the previous integrated values prior to the execution of the integration process by the integrators 41i, 41q, the modulation period T0 is set to a period of time in which the integration outputs of the integrators 41i, 41q does not reach the final value in a case in which the integrated values by the integrators 41i, 41q are the maximum values in the possible range of the integrated values.

Condition B: In a state in which the integrators 41i, 41q are preset to the previous integrated values prior to the execution of the integration process by the integrators 41i, 41q, the modulation period T0 is set to a period of time in which the integration outputs of the integrators 41i, 41q reaches the final values through repeated execution of the integration process by the integrators 41i, 41q.

According to the present embodiment, at the beginning of the position detection by the position detecting device, the calculation accuracy of the first integrated value V1 and the second integrated value V2 by the integrators 41i, 41q is relatively low. However, subsequent repetition of the integration process by the integrators 41i, 41q causes the first integrated value V1 and the second integrated value V2, which are calculated through the integration process, to have appropriate values. This ensures accuracy of position detection by the position detecting device.

Further the present embodiment shortens the modulation period T0 as compared to a device of a comparative example that does not preset the integrators 41i, 41q to the previous integrated values prior to the execution of the integration process by the integrators 41i, 41q, and in which the modulation period T0 is set to a period of time in which the final values of the integration outputs of the integrators 41i, 41q are changed to appropriate values even if the integrated values by the integrators 41i, 41q are any values in the possible range. This allows the position detecting device to quickly detect the position of an object, and shortens the updating cycle of detection.

As described above, the present embodiment provides the following advantages.

(1) Prior to the execution of the integration process by the integrators 41i, 41q, the integrators 41i, 41q are preset to the integrated values that were calculated in the previous integration process by the integrators 41i, 41q. This allows the position detecting device to quickly detect the position of an object, and shortens the updating cycle of detection.

(2) The previous integration process, which calculates the previous integrated values, and the current integration process, in which a presetting operation is performed using the previous integrated values, are the integration processes that integrate multiplication signals that have components the phase of which is synchronized with the same modulated signal stream. Accordingly, prior to the integration process by the integrators 41i, 41q, the initial values of the integration outputs of the integrators 41i, 41q are set to time integrals of signal waves that have components of which the phase is synchronized with the modulated signal stream of the same phase (specifically, integrated values by the integrators 41i, 41q). The time integrals are integrated values that were calculated by the previous integration process.

(3) At the integration of the first multiplication signal by the integrator 41i, the integration of the first multiplication signal is prohibited during the distortion superimposing period T1. Also, at the integration of the second multiplication signal by the integrator 41q, the integration of the second multiplication signal is prohibited during the distortion superimposing period T1. Thus, in the distortion superimposing period T1, in which a distortion of a waveform may occur, the signal value of the first multiplication signal and the signal value of the second multiplication signal stop being used in the integration process by the integrators 41i, 41q. This limits reduction in the position detection accuracy due to superposition of waveform distortion.

(4) The process of integrating the first multiplication signal is prohibited during the entire period of time from when a transition of the signal level of the first modulated signal stream takes place until when the defined period of time elapses. Also, the process of integrating the second multiplication signal is prohibited during the entire period of time from when a transition of the signal level of the second modulated signal stream takes place until when the defined period of time elapses. The influence of waveform distortion is maximized immediately after a transition of the signal level and then gradually decreases. The present embodiment prohibits the process of integrating the first multiplication signal and the second multiplication signal during the period of time in which the influence of waveform distortion is maximized. This limits reduction in the position detection accuracy due to superposition of waveform distortion in a preferably manner.

The above-described embodiment may be modified as follows. The above-described embodiment and the following modifications can be combined as long as the combined modifications remain technically consistent with each other.

The previous integration process, which calculates the previous integrated values, and the current integration process, in which a presetting operation is performed using the previous integrated values, may be integration processes that integrate multiplication signals that have components the phase of which is synchronized with different modulated signal streams. Specifically, the previous integration process may be the integration process by the integrator 41i, and the current integration process may be the integration process by the integrator 41q. Also, the previous integration process may be the integration process by the integrator 41q, and the current integration process may be the integration process by the integrator 41i.

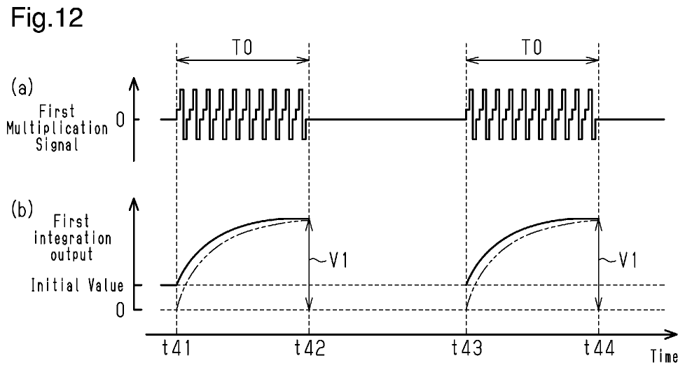

As shown in FIG. 12, the initial values of the integration outputs of the integrators 41i, 41q may be each set to a previously designated value during a period of time from when the previous integration process by the integrators 41i, 41q (from a point in time t41 to a point in time t42) is completed to when the current integration process by the integrators 41i, 41q (from a point tine t43 to a point in time t44) is started.

The “designated value” may be a median of the possible range of the integrated values by the integrators 41i, 41q, or a value obtained by multiplying the previous integrated value by a specific value (where, 0<specific value<1). Also, a device in which the integrated values calculated by the integrators 41i, 41q are substantially constant due to a substantially fixed position of an object, the “designated values” may be set to values corresponding to the integrated values.

According to the above-described configuration, prior to the execution of the integration process by the integrators 41i, 41q, the initial values of the integration outputs of the integrators 41i, 41q are set to designated values that are not 0, so that the initial values are brought closer to the final values of the integration outputs (values equal to the time integrals of the first multiplication signal or the second multiplication signal) in advance. Thus, as compared to a device of a comparative example in which the initial values of the integration outputs of the integrators 41i, 41q are set to 0 (indicated by the long-dash double-short-dash line in FIG. 12), the values of the integration outputs of the integrators 41i, 41q in the current integration process are changed to appropriate values (values equal to the time integrals of the first multiplication signal and the second multiplication signal) at an early stage. Thus, appropriate values are obtained as the final values of the integration outputs of the integrators 41i, 41q in the modulation period T0, even if the modulation period T0 is short.

The modulation period T0 does not necessarily need to be a previously defined period of time, but may be set variably. For example, the initial modulation period T0 after the position detecting device is activated may be relatively long, and the modulation period T0 may be shortened thereafter. With this configuration, during the initial modulation period T0 after the position detecting device is activated, that is, during a period of time in which the initial values of the integration outputs of the integrators 41i, 41q are 0, the integration process of the integrators 41i, 41q is executed for a relatively long period of time, so that the integrated values are changed from 0 to appropriate values. Thus, from an early stage of the position detection by the position detecting device, the integrated values by the integrators 41i, 41q (the first integrated value V1 and the second integrated value V2) are calculated with a high accuracy. Further, in the subsequent the modulation periods T0, the integrators 41i, 41q are preset to the previous integrated values, which were calculated in the initial modulation period T0, so that the integrated values are changed to appropriate values in a relatively short period of time through the integration process by the integrators 41i, 41q. This shortens the modulation period T0 and allows the position detecting device to quickly detect the position of an object, thereby shortening the updating cycle of detection.

The mask units 40i, 40q may be omitted. That is, the first multiplication signal output from the multiplier 39i may be directly input to the integrator 41i. Also, the second multiplication signal output from the multiplier 39q may be directly input to the integrator 41q.

The position detecting device does not necessarily need to have a base of a three-layer structure. For example, the position detecting device may include a single layer structure in which the light-receiving element 24 is mounted on the lower surface (back surface) of the upper layer base 23, and light is received on the mounted surface of the light-receiving element 24. In this case, the light-receiving element 24 is preferably potted in a sealing material having a light shielding property, so as to avoid influence of stray light onto the back surface.

The above-described embodiment may be applied to a position detecting device that includes multiple groups of light-emitting elements arranged on the same straight line. Such a position detecting device may have two groups of four light-emitting elements 26L, 26R, 27L, 27R, in which lines along which the light-emitting elements are arranged are orthogonal to each other.

The configuration according to the above-described embodiment may be applied to a position detecting device that outputs, as drive signals for driving light-emitting elements, two types of modulated signal streams (a first modulated signal stream and a second modulated signal stream) of which the phases are displaced from each other by an angle other than 90 degrees. Further, the configuration according to the above-described embodiment may be applied to a position detecting device that outputs two types of modulated signal streams (a first modulated signal stream and a second modulated signal stream), with which a state in which only the first light-emitting elements emit light and a state in which the second light-emitting elements emit light are repeated alternately.

The configuration according to the above-described embodiment is not limited to a position detecting device that detects both the position and the tilt angle of the object OB, but may be applied to a position detecting device that detects only one of the position and the tilt angle of the object OB.

Technical concepts obtained from the above-described embodiment and the modifications will now be described.

Technical Concept A

A position detecting device, comprising:

a timing generating unit that repeatedly and separately generates modulated signal streams of different phases at intervals;

light-emitting units that emit optical signals that are intensity-modulated using the modulated signal streams of different phases;

a light-receiving unit that receives reflected light and converts the reflected light into an analog signal, the reflected light being the optical signal reflected by an object;

an AD conversion unit that converts the analog signal into a digital signal by sampling the analog signal at a frequency higher than a modulation frequency related to the intensity-modulation using the modulated signal stream;

a demodulating unit that demodulates the digital signal to obtain a signal wave that has a component a phase of which is synchronized with one of the modulated signal streams of different phases;

an integrator that integrates the signal wave obtained by the demodulating unit; and

a computation unit that calculates a position of the object based on an integration output of the integrator,

wherein the integrator is configured to prohibit the process of integrating the signal wave in at least part of a period of time from when a transition of a signal level of any of the modulated signal streams of different phases takes place until when a defined period of time elapses.

Technical Concept B

The position detecting device according to Technical Concept A, wherein the integrator is configured to prohibit the process of integrating the signal wave in the entire period of time until when the defined period of time elapses.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A position detecting device, comprising:
a timing generating unit that repeatedly and separately generates modulated signal streams of different phases at intervals;
light-emitting units that emit optical signals that are intensity-modulated using the modulated signal streams of different phases;
a light-receiving unit that receives reflected light and converts the reflected light into an electric signal, the reflected light being the optical signal reflected by an object;
a demodulating unit that demodulates the electric signal to obtain a signal wave that has a component a phase of which is synchronized with one of the modulated signal streams of different phases;
an integrator that integrates the signal wave obtained by the demodulating unit; and
a computation unit that calculates a position of the object based on an integration output of the integrator,
wherein, before integrating the signal wave that has a component a phase of which is synchronized with the current modulated signal stream, the integrator is preset to a final value of the integration output related to the signal wave that has a component a phase of which is synchronized with the previous modulated signal stream.

2. The position detecting device according to claim 1, wherein the previous modulated signal stream and the current modulated signal stream are modulated signal streams of a same phase.

3. The position detecting device according to claim 1, wherein
the modulated signal streams are signals having rectangular waves,
an AD conversion unit is provided between the light-receiving unit and the demodulating unit, the AD conversion unit converting the analog signal output from the light-receiving unit into a digital signal by sampling the analog signal at a frequency higher than a modulation frequency related to the intensity-modulation using the modulated signal stream, and
the integrator is configured to
integrate the signal wave obtained by demodulating the digital signal by the demodulating unit, and
prohibit the process of integrating the signal wave in at least part of a period of time from when a transition of a signal level of any of the modulated signal streams of different phases takes place until when a defined period of time elapses.

4. The position detecting device according to claim 3, wherein the integrator is configured to prohibit the process of integrating the signal wave in the entire period of time until when the defined period of time elapses.

5. A position detecting device, comprising:
a timing generating unit that repeatedly and separately generates modulated signal streams of different phases at intervals;
light-emitting units that emit optical signals that are intensity-modulated using the modulated signal streams of different phases;
a light-receiving unit that receives reflected light and converts the reflected light into an electric signal, the reflected light being the optical signal reflected by an object;
a demodulating unit that demodulates the electric signal to obtain a signal wave that has a component a phase of which is synchronized with one of the modulated signal streams of different phases;
an integrator that integrates the signal wave obtained by the demodulating unit; and
a computation unit that calculates a position of the object based on an integration output of the integrator,
wherein the integrator is set to a previously designated value during a period of time from when integration of the signal wave that has a component a phase of which is synchronized with the previous modulated signal stream is completed until when integration of the signal wave that has a component a phase of which is synchronized with the current modulated signal stream is started.

6. The position detecting device according to claim 5, wherein
the modulated signal streams are signals having rectangular waves,
an AD conversion unit is provided between the light-receiving unit and the demodulating unit, the AD conversion unit converting the analog signal output from the light-receiving unit into a digital signal by sampling the analog signal at a frequency higher than a modulation frequency related to the intensity-modulation using the modulated signal stream, and
the integrator is configured to
integrate the signal wave obtained by demodulating the digital signal by the demodulating unit, and
prohibit the process of integrating the signal wave in at least part of a period of time from when a transition of a signal level of any of the modulated signal streams of different phases takes place until when a defined period of time elapses.

7. The position detecting device according to claim 6, wherein the integrator is configured to prohibit the process of integrating the signal wave in the entire period of time until when the defined period of time elapses.
